(19) United States
(12) Patent Application Publication
(10) Pub. No.: US 2019/0230869 A1
(43) Pub. Date: Aug. 1, 2019

(54) System for Transporting Plant Clones

(71) Applicant: Gilad Krakover, Even-Yehuda (IL)

(72) Inventor: Gilad Krakover, Even-Yehuda (IL)

(21) Appl. No.: 15/881,823

(22) Filed: Jan. 29, 2018

(51) Int. Cl. A01G 9/029; B65D 81/22; B65D 81/05; A01G 13/02

(52) U.S. Cl. CPC A01G 9/0299; A01G 13/0243; B65D 81/052; B65D 81/22

(57) ABSTRACT

The present invention provides a system for transporting plant clones that have developed root systems outside solid cultivating media. The transporting system comprises stem collars that hold plant clones. The stem collars are made of biodegradable materials so that plant clones can be transplanted to the field with the collars. The plant clone transporting system also comprises a collar tray to hold stem collars and a portable tank to hold water or solid media that holds water, such as rockwool and perlite, to provide favorable conditions to the root systems of the plant clones, so they can survive a long transportation.

### REFERENCE TO RELATED APPLICATIONS

This is a first-filed application.

### BACKGROUND OF THE INVENTION

### Field of the Invention

The present invention relates to the field of horticultural systems and methods. Particularly, the present invention relates to transportation of plant clones.

### Motivation and Description of Related Art

Plant cloning is a technique for asexually propagating plants where a cutting of the stem or root is used to produce a new plant independent of the parent. The plant cuttings for growing the clones need to be placed in a suitable medium or environment to cultivate the roots. One of the approaches for plant cloning is to use a aeroponic system. In this approach, the clones are cultivated in a closed or semi-closed environment by spraying the plant's roots with water or water-based solution. Aeroponic cloning systems provide many desirable advantages over medium-based growing systems. For example, aeroponic growing increases aeration and delivers more oxygen to plant roots, stimulating growth and helping to prevent pathogen formation and put less stress on the plants. Aeroponics can also limit disease transmission since plant-to-plant contact is reduced. Due to the disease-free environment that is unique to aeroponics, many plants can grow at higher density compared to traditional forms of cultivation. Aeroponics allows the whole process of plant cloning to be carried out in a single, automated unit, by initiating faster and cleaner root development through use of a sterile, highly oxygenated, and moist environment. Aeroponic systems also produce cloned plants with healthier root systems.

When plant clones are ready to be transplanted in the field, they need to be transported from the cultivation facilities, sometimes over a significant travel distance. Clones grown in solid cultivating media such as rockwool, peat moss, and coco peat are relatively easy to transport. The plant clones can be placed in a plastic tray with the cultivating media attached to their roots for transportation to the field. Since the cultivating media can hold moisture, the plant clones can survive in them over a long transportation. Once they arrive the field, the plant clones can be transplanted in the soil with the cultivating media attached.

A plant cutting which has not rooted can be placed into cultivating media by puncturing a hole in the medium and inserting the stem of the cutting. For aeroponic or hydroponic clones that have already developed root systems in a mist or liquid environment, however, inserting them into cultivating media are difficult. Currently there are no good solutions for transporting these clones.

Therefore, there is continued need for systems for transporting plant clones that have developed root systems outside solid cultivating blocks.

### SUMMARY OF THE INVENTION

The objective of the present invention to provide a system for transporting plant clones that have developed root systems outside solid cultivating blocks. Examples of the clones transported by the system in the present invention include aeroponically or hydroponically cultivated plant clones.

In one aspect of the present invention, the transporting system comprises stem collars that hold the plant clones. These collars are designed to be used during the aeroponic or hydroponic cultivation as well as the transportation of the clones. The plant stem cuttings can be easily inserted into the collar and held securely in the cloning apparatus and in the transporting system. The collars are made of biodegradable materials. Therefore, plant clones can be transplanted to the field with the collars attached.

Another aspect of the present invention comprises a collar tray in which the stem collars are placed in. The collar tray comprises apertures into which the stem collars can be inserted. In some embodiments of the present invention, the stem collars have a shape of a truncated cone with a larger circular top surface and smaller circular bottom surface. The diameter of the top surface is slightly greater than the diameter of the receiving aperture of the collar tray and the diameter of the bottom surface is slightly smaller than the diameter of the receiving aperture. This way, the clone collar can be inserted snuggly into the receiving aperture without falling through.

Another aspect of the present invention comprises a portable tank on top of which the collar tray can be placed. The tank holds water or moist media such as rockwool, perlite, or other neutral media that can hold water to provide favorable conditions to the root systems of the plant clones, so that they can survive a long transportation.

In another aspect of the present invention, the collar tray can be used in a cloning apparatus with the stem collars. Once the cultivation process is completed, the collar tray can be removed with the stem collars and plant clones to be carried in one unit for transportation. This eliminates the time-consuming process of taking out the stem collar one by one from the cloning apparatus and putting them in the transportation unit. In addition, the collar tray is designed to be light weighted and can be constructed with a plastic material. It is easy to carry and may be disposable.

In some embodiments of the present invention, the collar tray comprises handles on its periphery to make it convenient to carry. Furthermore, in some embodiments, the handles protrude under the collar tray. The tank sidewalls have matching indentations at the top, so that the handle protrusions fit in the indentations when the collar tray is placed on top of the tank. The coupling of the handle protrusions and the tank sidewall indentations prevent the collar tray from laterally sliding over the tank and thus provide a more secure fitting.

The above invention aspects will be made clear in the drawings and detailed description of the invention.

### BRIEF DESCRIPTION OF THE DRAWINGS

FIG. 1 is a perspective view of an embodiment of the plant clone transport system when assembled.

FIG. 2 is an exploded view of the embodiment of the plant clone transport system in FIG. 1.

FIG. 3 is a perspective view of the collar tray in the plant clone transport system of FIG. 1.

FIG. 4 is a perspective view of the tank in the plant clone transport system of FIG. 1.

FIG. 5A is a perspective view of a stem collar used in the plant clone transport system.

FIG. 5B is a top view of one of the stem collar of FIG. 5A.

FIG. 5C is a perspective view of the stem collar of FIG. 5A when the slit opens up wider to accommodate a thicker stem of particular plant clone.

FIG. 5D is a top view of the stem collar of FIG. 5C.

### REFERENCE NUMERALS IN THE DRAWINGS

Reference is now made to the following components of embodiments of the present invention:
100 Plant clone transport system
110 Collar tray
112 Collar tray body
114 Collar receiving aperture
116 Collar tray handle
117 Handle protrusion
118 Collar tray raised ridge
150 Tank
151 Tank bottom
152 Tank sidewall
154 Support column
156 Tank sidewall indentation
158 Tank raised ridge
180 Stem collar
182 Stem collar body
184 Stem collar center hole
186 Stem collar slit
188 Stem collar top surface
189 Stem collar bottom surface

### DETAILED DESCRIPTION OF THE INVENTION

In the detailed description, numerous specific details are set forth in order to provide a thorough understanding of the invention. However, it will be understood by those skilled in the art that these are specific embodiments, and that the present invention may be practiced also in different ways that embody the characterizing features of the invention as described and claimed herein.

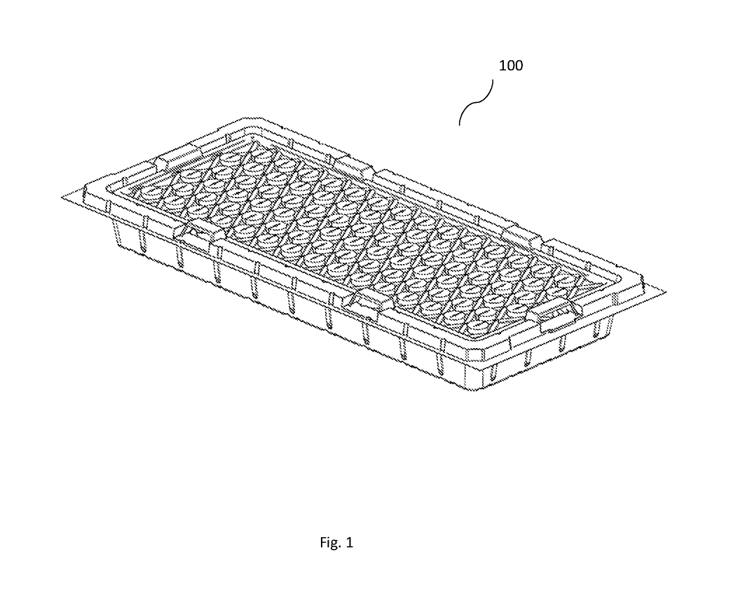

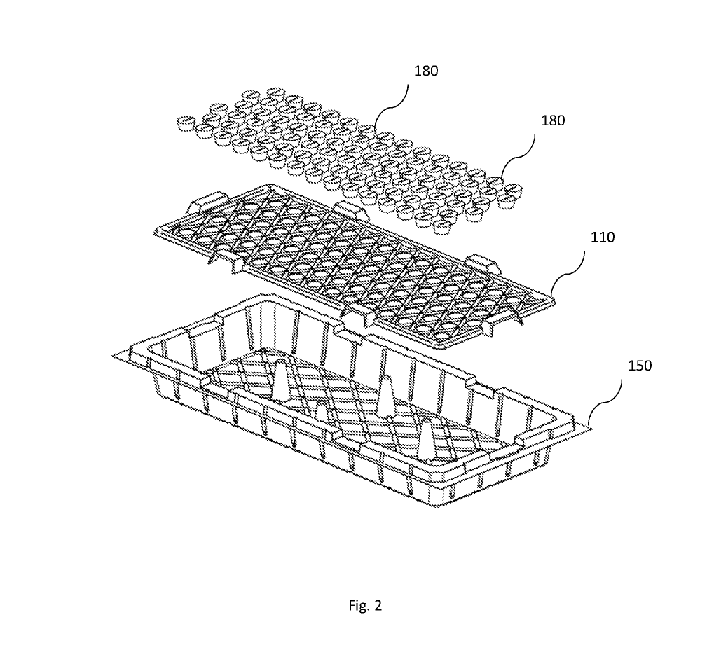

FIGS. 1-5 show an embodiment of the plant clone transport system 100. As shown in the explosive view of FIG. 2, the plant clone transport system 100 comprises a tank 150, a collar tray 110, and a collection of stem collars 180. The stem collars 180 are used to hold the plant clones. They are secured to the collar tray 110 when the plant clones are in transportation. The collar tray is placed on top of the tank 150 which holds water or moist media such as rockwool, perlite, or other neutral media that can hold water to provide favorable conditions to the root systems of the plant clones, so that they can survive a long transportation.

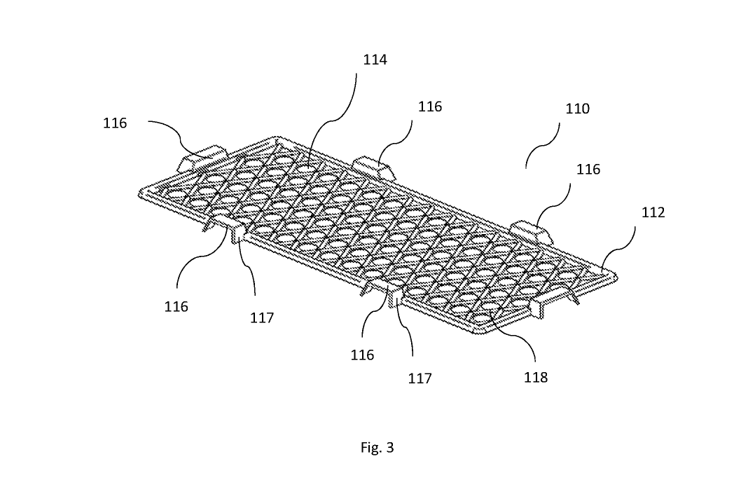

As shown in FIG. 3, the collar tray 110 comprises a flat rectangular collar tray body 112 having an array of apertures 114 to receive the stem collars 180. In certain embodiments, the apertures 114 are circular in shape. In certain embodiments, the collar tray 110 further comprises several handles 116 located on the periphery of the collar tray body 112. The handles 116 assist easy lifting and carrying the collar tray. In a preferred embodiment, the collar tray 110 is made of plastic. In certain embodiments, the collar tray 110 further comprises a grid of raised ridges 118 on the rectangular body 112. These raised ridges 118 mechanically reinforce the collar tray body 112 without significantly adding weight and material. In a preferred embodiment, the collar tray 110 can be used in a cloning apparatus with the stem collars 180. Once the cultivation process is completed, the collar tray 110 can be removed with the stem collars 180 and plant clones to be carried in one unit for transportation. This eliminates the time-consuming process of taking out the stem collar one by one from the cloning apparatus and putting them in the transportation unit. In a preferred embodiment, the collar tray 110 is disposable.

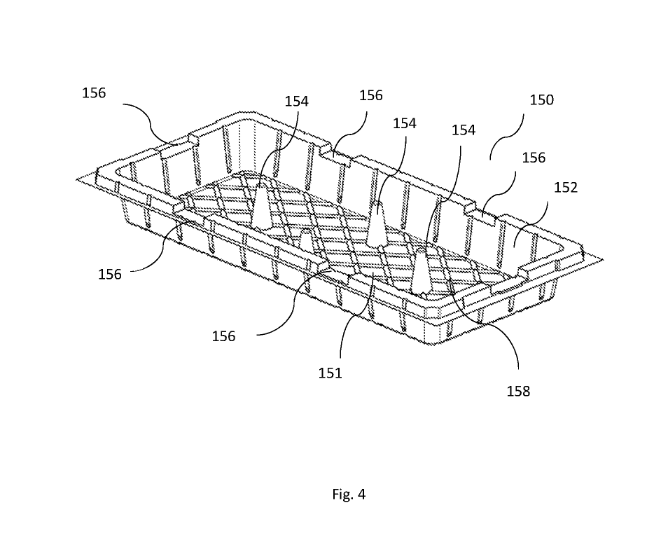

As shown in FIG. 4, the tank 150 is slim in design to make the system portable. The tank 150 comprises a tank bottom 151 and sidewalls 152. In certain embodiments, the tank 150 further comprises one or more support columns 154 extending vertically from the tank bottom 151. When the collar tray 110 is placed on top of the tank 150 (as shown in FIG. 1), the weight of the collar tray 110 distributes on the top edges of the tank walls 152, on the handles 156, and on the support columns 154, providing better support to prevent sagging of the collar tray 110. In certain embodiments, the tank bottom 151 also comprises a grid of raised ridges 158 to mechanically reinforce the tank bottom 151 without significantly adding weight and material. In a preferred embodiment, the tank 150 is shaped so that multiple tanks can stack into a compact pile to save storage space.

As shown in FIG. 3, in certain embodiments, the handles 116 protrude under the collar tray 110. The tank sidewalls 152 have matching indentations 156 at the top edges (as shown in FIG. 4) so that the handle protrusions 117 (in FIG. 3) fit in the indentations when the collar tray 110 is placed on top of and align with the tank 150. This fitting is illustrated in the ensembled view of FIG. 1. The coupling of the handle protrusions 117 and the tank sidewall indentations 156 prevent the collar tray 110 from laterally sliding over the tank 150 and thus provide a more secure fitting.

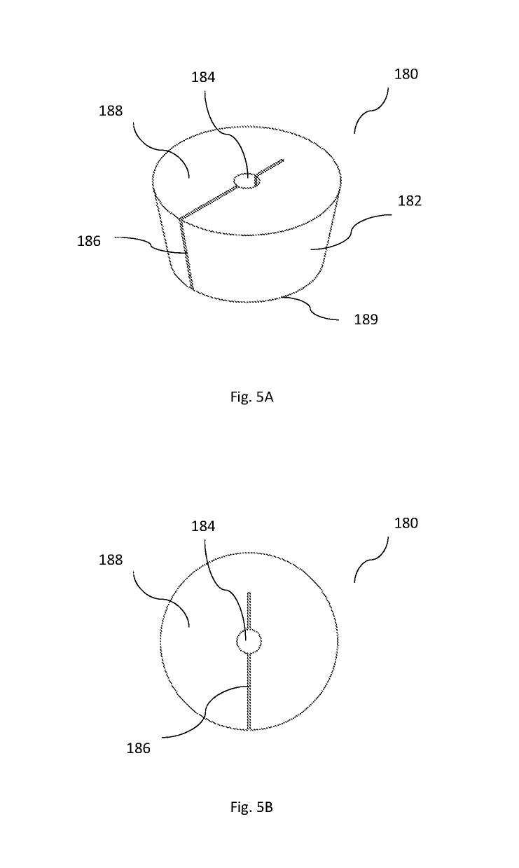

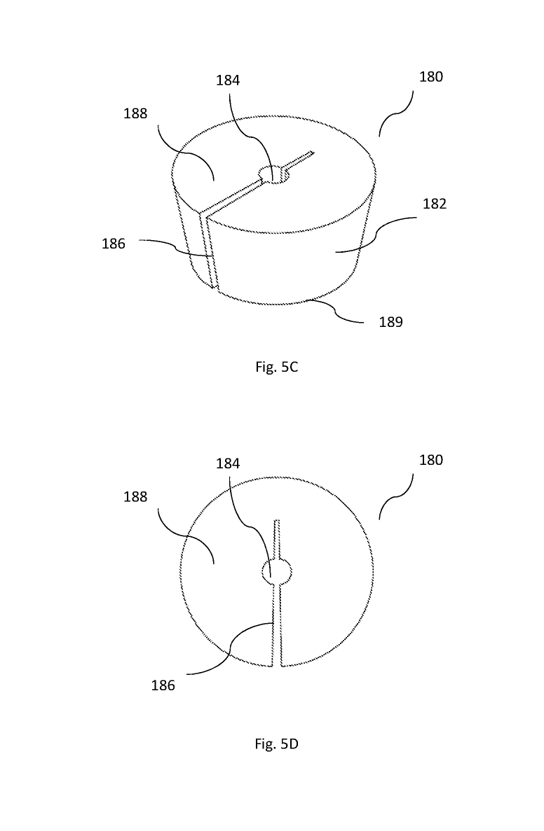

An embodiment of the stem collar 180 is illustrated in FIG. 5A (perspective view) and FIG. 5B (top view). In this embodiment, the stem collar 180 has a body 182 with a shape of truncated cone with a circular top surface 188 and a circular bottom surface 189. The diameter of the circular top surface 188 is slightly greater than the diameter of the receiving aperture 114 of the collar tray 110 and the diameter of the circular bottom surface 189 is slightly smaller than the diameter of the receiving aperture 114. This way, the stem collar 180 can fit snuggly in the receiving aperture 114 without falling through. The stem collar has a center hole 184 and a vertical slit 186 cut through the thickness of the collar to hold a stem of a plant cutting. The slit 186 intersect with the center hole 184. The stem collars 180 are designed to be used during aeroponic or hydroponic cloning as well as transportation of the clones. The plant stem cuttings can be easily inserted into the collar through the center hole 184 or the slit 186. In a preferred embodiment, the stem collar 180 is made of biodegradable material, such as cork, so that the plant clones can be transplanted in the field with the stem collars 180 still attached.

In general, the stem collar 180 is made of a material that is not completely rigid. The slit 186 can be opened up a little wider with mechanical force, as shown in FIGS. 5C and 5D. The truncated-cone shape of the stem collar body 182 combined with the slit 186 structure allow the stem collar 180 to fit the receiving apertures 114 of the supporting tray 110 without putting pressure on the stems of the plant clones. For example, if the stem of a plant clone has a cross-section greater than the center hole 184 of the stem collar 180, the slit 186 can open up a little wider to accommodate the stem of the plant clones, as shown in FIGS. 5C and 5D. The truncated-cone shape of the stem collar body 182 make it possible to adjust the fitting of the stem collar 180 into the receiving aperture 114 in the collar tray 110 by adjusting how far the stem collar 180 is vertically inserted to the receiving aperture 114. For example, when the slit 186 opens up wider to accommodate a stem of particular plant clone, the stem collar 180 can still fit into the receiving aperture 114 without squeezing on the stem as long as the stem collar 180 is not inserted to the receiving aperture too far vertically.

The foregoing description and accompanying drawings illustrate the principles, preferred or example embodiments, and modes of assembly and operation, of the invention; however, the invention is not, and shall not be construed as being exclusive or limited to the specific or particular embodiments set forth hereinabove.

What is claimed is:

1. A system for transporting plant clones, comprising:
a portable tank configured to hold liquid or moist plant growing media, the portable tank comprising a bottom and sidewalls;
one or more stem collars for holding plant clones, each of the stem collars comprising a stem collar body and a hole cut through the thickness of the stem collar body for a stem of plant cutting to be inserted; and
a collar tray configured to be fit on top of the portable tank, the collar tray comprising an essentially flat collar tray body and plurality of apertures in the collar tray body, the apertures configured for the stem collars to be inserted in.

2. The system for transporting plant clones in claim 1, wherein
each of the stem collars further comprises a vertical slit cut through the thickness of the collar body, the vertical slit intersecting with the hole of the stem collar; and
each of the stem collars is made of a material that is not completely rigid so that the vertical slit can be opened wider with mechanical force.

3. The system for transporting plant clones in claim 1, wherein
the apertures in the collar tray are circular in shape;
the stem collar body of each of the stem collars has an overall shape of a truncated cone having a top circular surface and a circular bottom surface;
the diameter of the top circular surface of the stem collar body is greater than the diameter of the apertures in the collar tray; and
the diameter of the top circular surface of the stem collar body is smaller than the diameter of the apertures in the collar tray.

4. The system for transporting plant clones in claim 1, wherein the stem collars are made of a bio-degradable material.

5. The system for transporting plant clones in claim 4, wherein the stem collars are made of cork.

6. The system for transporting plant clones in claim 1, wherein the tank further comprises one or more support columns extending vertically from the bottom of the tank, the support columns configured to bear some of the weight of the collar tray when the collar tray is placed on top of the tank.

7. The system for transporting plant clones in claim 1, wherein the bottom of the tank comprises a plurality of raised ridges to mechanically reinforce the tank without significantly adding weight and material.

8. The system for transporting plant clones in claim 1, wherein the tank is made of plastic.

9. The system for transporting plant clones in claim 1, wherein the collar tray further comprises a plurality of handles located on the periphery of the collar tray body.

10. The system for transporting plant clones in claim 1, wherein
the collar tray further comprises a plurality of protrusion structures extending vertically under the collar tray body;
the sidewalls of the tank comprises a plurality of indentations structures configured to match with the protrusion structures of the collar tray; and
when the collar tray placed on top of the tank, the protrusion structures of the collar tray and fit into the indentations structures of the sidewalls of the tank, so that the coupling of the protrusion structures and the indentation structures prevent the collar tray from laterally sliding over the tank.

11. The system for transporting plant clones in claim 1, wherein the collar tray body further comprises a plurality of raised ridges to mechanically reinforce the collar tray without significantly adding weight and material.

12. The system for transporting plant clones in claim 1, wherein the collar tray is made of plastic.

13. A stem collar for holding a stem of plant cutting during cultivation or transportation of the plant cutting, comprising:
a stem collar body having a shape of a truncated cone;
a hole cut through the thickness of the stem collar body for a stem of plant cutting to be inserted; and
a vertical slit cut through the thickness of the collar body, the vertical slit intersecting with the hole of the stem collar;
wherein the stem collar is made of a material that is not completely rigid, so that the vertical slit can be opened wider with mechanical force.

14. The stem collar in claim 13, wherein stem collar is made of a bio-degradable material.

15. The stem collar in claim 14, wherein the stem collar is made of cork.

16. A collar tray for plant clone cultivation and transportation, the collar tray configured to be placed on top of a portable tank or fit in a plant clone cultivation apparatus, the collar tray comprising:
an essentially flat collar tray body and plurality of circularly-shaped apertures in the collar tray body, the apertures configured for a plurality of stem collars to be inserted in; and
a plurality of handles located on the periphery of the collar tray body.

17. The collar tray for plant clone cultivation and transportation in claim 16, wherein the collar tray body further comprises a plurality of raised ridges to mechanically reinforce the collar tray without significantly adding weight and material.
